(19) United States
(12) Patent Application Publication
(10) Pub. No.: US 2023/0053775 A1
(43) Pub. Date: Feb. 23, 2023

(54) HIGH PROTEIN FLOWABLE BATTER AND METHODS OF PROCESSING THEREOF

(71) Applicant: Kellogg Company, Battle Creek, MI (US)

(72) Inventor: Carol SAADE, Redondo Beach, CA (US)

(21) Appl. No.: 17/797,329

(22) PCT Filed: Feb. 4, 2021
(86) PCT No.: PCT/US2021/016516

§ 371 Date: Aug. 3, 2022

Related U.S. Application Data
(60) Provisional application No. 62/970,315, filed on Feb. 5, 2020.

(51) Int. Cl. A21D 10/04; A21D 13/064; A21D 2/26; A21D 2/02; A21D 2/16; A21D 13/45

(52) U.S. Cl. CPC A21D 10/04; A21D 13/064; A21D 2/266; A21D 2/02; A21D 2/165; A21D 13/45

(57) ABSTRACT

A method of producing a high-protein batter by preparing a first mixture by combining protein, water, and an acidic leavening system. The method further includes mixing the first mixture for a first period of time. A second mixture is prepared by combining at least the first mixture, flour, sweetener, and an alkaline leavening agent. The second mixture is mixed for a second period of time, and then baked to form a high protein baked product such as a waffle.

### CROSS REFERENCE TO RELATED APPLICATIONS

This application claims priority under 35 U.S.C. § 119 to U.S. Provisional Application Nos. 62/970,315 filed on Feb. 5, 2020. The entire contents of the aforementioned application are incorporated herein.

### FIELD

This disclosure relates to high-protein batters, and particularly, to methods of processing high-protein batters to maintain pourablity and/or flowability.

### BACKGROUND

Batters are commonly thin, dough-like mixtures that can be poured into a pan or other receptacle or coated onto food surfaces for subsequent cooking, baking, or frying. Batters are commonly used for pancakes, waffles, or coatings for various types of baked or fried foods, but have other suitable uses when cooking, baking, or frying. Flowability or maintaining a pourable viscosity of the batter is often helpful when processing the batter with such cooking uses. However, maintaining a pourable or flowable batter consistency is often a challenge when attempting to prepare a high-protein composition having greater than about 10 percent protein.

High levels of protein in food batters present challenges in processing due to interaction of the proteins with liquids and other dry ingredients within the batter. Increasing levels of protein in a batter impacts the consistency, viscosity, and/or texture of the batter. When increasing the level of protein over about 10 percent, prior batters tend to be too thick to maintain sufficient flowability due to protein hydration. Proteins often quickly absorb too much water relative to other batter components increasing the viscosity to unacceptable levels. Thus, prior batters generally have been limited to about 10 percent or less protein due to such processing difficulties.

Attempts to improve the processing of high protein batters seek to separate the ingredient blending into multiple mixing steps and/or attempting to coat proteins with a fat or other barrier to hinder or slow protein hydration. While such prior methods may help with the processing of certain high-protein batters, such methods are less robust and sensitive to the protein composition because such prior methods and compositions are unable to form flowable or pourable batters with all types of proteins.

### SUMMARY

In one aspect or embodiment, a method of preparing a high-protein batter for maintaining flowability of the batter is described in this disclosure. The method includes blending a protein source, water, and an acidic leavening system and optionally a calcium salt to form an acidified high-protein protein slurry. This acidified high-protein protein slurry may have a pH below the isoelectric point of the protein source, preferably a pH of about 4.5 or below. Next, the acidified high-protein protein slurry is added to hydrated dry ingredients or dry ingredients added to the slurry to form a batter. Then, a fat and optionally an emulsifier may be added to the batter. Lastly, the batter is neutralized through addition of an alkaline leavening system to form a neutralized high-protein batter having about 8 to about 14 weight percent protein; and preferably, greater than 10 weight percent protein to about 14 weight percent protein.

The methods of the previous paragraph may include other features, aspects and/or embodiments in any combination thereof These additional features, aspects, and/or embodiments include any combination of the following: wherein the protein source is selected from whey protein, soy protein, wheat gluten, peanut protein, pea protein, or mixtures thereof; and/or wherein the protein source is soy protein selected from soy protein isolate, soy protein concentrate, or combinations thereof, and/or wherein the acidic leavening system includes one or more ingredients selected from citric acid, lactic acid, malic acid, fumaric acid, adipic acid, acetic acid, tartaric acid, phosphoric acid, monocalcium phosphate monohydrate, anhydrous monocalcium phosphate, anhydrous dicalcium phosphate, dicalcium phosphate dihydrate, sodium acid pyrophosphate, sodium aluminum phosphate, monoaluminum phosphate, dialuminum phosphate, monoammonium phosphate, diammonium phosphate, sodium aluminum sulfate, salts thereof or mixtures thereof; and/or wherein the dry ingredients are selected from flour, starches, sweeteners, fortificants, spices, salt, colorants, other protein sources, gums, preservatives, flavors, or combinations thereof; and/or wherein the fat is selected from non-hydrogenated vegetable oil, non-hydrogenated shortening, partially hydrogenated vegetable oil, partially hydrogenated shortening, fully hydrogenated vegetable oil, fully hydrogenated shortening, soybean oil, cottonseed oil, canola oil, peanut oil, safflower oil, sunflower oil, coconut oil, palm oil, palm kernel oil, olive oil, butterfat oil, cocoa butter oil, tallow, lard, corn oil, or mixtures thereof; and/or wherein the emulsifier is selected from mono-glycerides, di-glycerides, propylene glycol monoester, propylene glycol diester, sodium steroyl lactylate, lecithin, polysorbate, sorbitan monostearate, glyceryl lacto ester, or mixtures thereof; and/or wherein the alkaline leavening system includes one or more ingredients selected from ammonium bicarbonate, potassium bicarbonate, sodium bicarbonate, or mixtures thereof; and/or wherein the pH of the neutralized high-protein batter is about 5.9 to about 6.5; and/or wherein the neutralized high-protein batter has about 8 to about 12 percent protein; and/or wherein the neutralized high-protein batter has a viscosity of about 5 to about 12 cm per about 10 seconds as measured by a Bostwick consistometer as described herein; and/or wherein a calcium salt is blended into the acidified high-protein slurry and/or with the dry ingredients; and/or wherein the acidified high-protein slurry includes the calcium salt and wherein the acidified high-protein slurry includes about 40 to about 50 mM of calcium ions provided by the calcium source; and/or wherein the calcium salt is calcium carbonate; and/or further including baking the neutralized high-protein batter; and/or wherein the baking is performed in a waffle iron to form a high protein waffle; and/or wherein the neutralized (final) high-protein batter includes about 8 to about 12 weight percent of the protein source, about 45 to about 48 weight percent water, about 0.5 to about 1.5 weight percent of the acidic leavening system, about 22 to about 26 weight percent of flour, about 5 to about 15 weight percent sweetener, about 5 to about 10 weight percent fat, about 0.1 to about 0.3 weight percent emulsifier, about 0.04 to about 0.8 weight percent of the alkaline leavening system (preferably about 0.04 to about 0.15 weight percent) ; and/or wherein the high protein batter includes about 5 to about 15 weight percent dry sweetener and about 0 to about 5 weight percent liquid sweetener; and/or wherein acidified high-protein slurry includes about 25 to about 38 weight percent of the protein source, about 68 to about 70 weight percent water, about 1.5 to about 4.5 weight percent of the acidic leavening system; and/or wherein the acidic leavening system incudes mono calcium phosphate (MCP) and sodium aluminum phosphate (SALP) in a leavening ratio of MCP to SALP of about 0.1 to about 0.4; and/or wherein about 40 to about 60 weight percent of the water is blended with the acidic leavening systems and the protein source to form the acidified protein slurry and the remaining portion of the water is blended with one or more of the dry ingredients to form a second slurry; and/or wherein the acidified high-protein slurry is added to the second slurry of hydrated dry ingredients; and/or wherein the one or more dry ingredients of the second slurry include one or more flavorants; and/or wherein liquid sweeteners selected from molasses, malt syrup, corn extract, invert sugar, and combinations thereof are blended into the acidified high-protein slurry.

### DETAILED DESCRIPTION

The present disclosure relates to high protein foods and batters for making high protein foods. The foods and batters include about 8 to about 14 weight percent protein (in other approaches, 10 to 14 weight percent, 10 to 12 weight percent, or greater than 10 weight percent in each instance) and, in some approaches, may also include greater than about 50 weight percent whole grains. In some approaches, these foods and batters may include about 9 to about 12 grams of protein per 70 gram serving size. As provided in the background, when preparing foods, such as muffins, cakes, pancakes, waffles, cones, corndogs, coatings, and the like, processing challenges arise when seeking to incorporate such high levels of protein and whole grain ingredients within the batters used to make such foods. The compositions and methods herein provide unique methods of processing such high protein batters to maintain flowability and pourablity. Unlike batters used in conventional batter-based food products, the batters of the present disclosure are prepared in a multi-stage process, whereby at least a first mixture (such as an acidified high-protein slurry) is prepared in a first stage using a first combination of ingredients effective to precipitate at least a portion of the protein out of solution, and then a second or further mixture or batter is prepared in a second stage (or subsequent stages) using a second combination of ingredients to which the first mixture is added in a manner to shift the proteins back into solution and maintain a flowable viscosity.

In one aspect, the methods herein describe a high-protein batter for maintaining a flowable and/or pourable viscosity of the batter during processing. In some approaches of this aspect, the methods include first adjusting the pH of water with an acid leavening system followed by blending a protein source to the mixture to form an acidified high-protein protein slurry. This acidified high-protein protein slurry has effective amounts of the acidic leavening system ingredients so that the acidified high-protein slurry has a pH, in some instances, of about 4.5 or below or, in other instances, a pH below the isoelectric point of the selected protein. Next, suitable dry ingredients for the batter are added to or blended with the acidified high-protein protein slurry to form an initial batter, which is blended or mixed as needed. In some approaches, the dry ingredients are first hydrated with water, and then the acidified protein slurry is gradually added to the hydrated dry mix while mixing. Thereafter, one or more fats or oils and optionally an emulsifier component may be added to the batter to form a second batter. Lastly, the batter is neutralized through addition of an alkaline leavening system to form a neutralized high-protein batter having about 8 to about 12 weight percent protein.

Without wishing to be limited by theory, the methods herein maintain batter flowablity throughout processing generally through the select pH of the protein mixture (that is, water, any liquid sugars, acid leavener system, and protein) prior to addition of dry ingredients. This way, the methods herein operate around or below the selected protein's isoelectric point. At the selected pH ranges herein, the protein precipitates in the system with higher protein-protein interactions and low protein-water interaction. Uniquely, such order of addition and method steps of the procedures described in this disclosure allow high levels of protein but still allow dry ingredients to properly hydrate at the same time.

Turning to more of the specifics, the protein source may be selected from whey protein, soy protein, wheat gluten, peanut protein, pea protein, or mixtures thereof In one approach, the protein source is soy protein and may be a soy protein selected from soy protein isolate, soy protein concentrate, or combinations thereof. Such proteins are blended with at least water and the acidic leavening system to form the acidified protein slurry. At the pH noted above, the proteins precipitate out of solution until the batter is neutralized at the end of processing.

The acidic leavening system includes one or more acidic leaveners selected from fumaric acid, adipic acid, acetic acid, tartaric acid, monocalcium phosphate monohydrate, anhydrous monocalcium phosphate, monocalcium phosphate (MCP), anhydrous dicalcium phosphate, dicalcium phosphate dihydrate, sodium acid pyrophosphate (SAPP), sodium aluminum phosphate (SALP), monoaluminum phosphate, dialuminum phosphate, monoammonium phosphate, diammonium phosphate, sodium aluminum sulfate, or mixtures thereof These acid leaveners are added in amounts effective to lower the pH of the batter and/or protein slurry of the first mixture of the process to or below the isoelectric protein of the selected protein, which may be about 4.5 or below depending on the selected protein source or mixture of protein sources used in the acidified protein slurry. In other cases, the pH may be 6.2 or below. For instance and in one approach, if the selected protein is one of the soy proteins, the acid leaveners are selected in amounts to achieve a pH of about 4.3 or below and, in other approaches, a pH of about 3.5 to about 4.3. The acid leaveners may be preferably be monocalcium phosphate, sodium aluminum phosphate, and/or combinations thereof. In systems using leaveners (acid and/or alkaline), acid leaveners may be preferred to manipulate the pH of the solution around the isoelectric point before adding the protein. In other systems, for recipes that do not use leaveners in their formulation using any food grade acid or corresponding salt will work such as, but not limited to, citric acid, acetic acid, fumaric acid, lactic acid, malic acid, tartaric acid, and phosphoric acid or their salts.

In some approaches, monocalcium phosphate by itself is advantageous as the acidic leavening agent when the protein source is one of the soy proteins. In this instance, amounts of such acidic leavener and protein combination effective to achieve a pH of about 4.3 or below (such as about 3.5 to about 4.3) form a pasty mixture (after all ingredients are combined) as opposed to an undesired curdy and/or crumbly protein. In other instances and depending on the protein type(s), the acidic leavening system may be a combination of monocalcium phosphate and sodium aluminum phosphate or, in yet other instances, sodium aluminum phosphate only and in yet other instances monocalcium phosphate only to achieve the pH of about 3.5 to about 4.3. In the approaches when a combination of acidic leaveners are used, the slurries, batters, and methods herein may have an acidic leavening system including mono calcium phosphate (MCP) and sodium aluminum phosphate (SALP) in a leavening ratio of MCP to SALP of about 0.1 to about 0.4 and, preferably, 0.3.

The water, selected protein source, and acidic leavening system are first blended to form a first mixture or the acidified high-protein slurry. This mixture or slurry may include about 68 to about 70 weight percent water, about 25 to about 37.5 weight percent protein (which may be one of the noted soy proteins), and about 1.5 to about 4.1 weight percent of the acidic leavening system (such as, about 0.9 to about 2.3 weight percent MCP, and about 0 to about 3.2 SALP weight percent). This slurry is then mixed for about 2 to about 3 minutes at a temperature of about 20 to about 23° C.

This first mixing step or slurry may also include optional components. In some approaches, for instance, the acidified high-protein slurry may also include one or more liquid sweeteners or liquid sugars, flavors, colorants, or any combinations of such components. If included in the first blend of the acidified high-protein slurry, this slurry may include about 0 to about 10 weight percent of the liquid sweeteners or other optional additives.

Optional liquid sweeteners or liquid sugars may include sucrose, dextrose, fructose, lactose, malt syrup, malt syrup solids, malt extract, rice syrup solids, rice syrup, invert sugar, malt syrup, malt syrup solids, refiners syrup, corn syrup, corn syrup solids, corn extract, maltose, high fructose corn syrup, honey, molasses, glycerrhizin, arabinose, galactose, glucose, mannitol, maple syrup, ribose, saccharin, xylose, artificial sweeteners, or mixtures thereof

In other optional steps, the acidified protein slurry may also contain a portion of the total water in the batter. In this approach, the water may be added stepwise in two or more steps to the slurry and/or the batter. For instance, the acidified high-protein slurry may include about 40 to about 60 weight percent of the total water in the final batter. Then in a second liquid step, after the acidified high-protein slurry is formed and mixed for the times noted above, the remaining portion of the water may be used to hydrate the dry ingredients as well as flavor or colorants (or other ingredients as needed) and thereafter the prepared acidified high-protein slurry is added to the latter hydrated dry mixture. If this two-step addition protocol is employed for the methods herein, the combined acidified high-protein slurry with the second hydrated mixture may then be mixed for another 2 to about 3 minutes at about 20 to about 23° C. to form the final batter.

In yet another optional approach, the acidified protein slurry may also include an added calcium salt, such as calcium carbonate, calcium chloride, calcium acetate, calcium citrate, or combinations thereof. If used, the acidified protein slurry may include about 0.7 to about 1.5 weight percent of the calcium salt. Without wishing to be limited by theory, adding the calcium salt may alter the ionic strength of the solution by changing the charge screening at the surface of the proteins. It is believed such change may also affect protein solubility in two different ways depending on the characteristics of the protein surface. At ionic strength less than about 0.5, for instance, soy protein's solubility decreases due to high incidence of nonpolar patches. At ionic strength (greater than about 1), salts have ion specific effects on protein solubility (salting out and salting in). At constant ionic strength, calcium cation decreases solubility of the protein. In some approaches, the addition of calcium carbonate may cause small amounts of gas formation from carbon dioxide due to the reaction with the acid leaveners in solution (such as MCP, SALP and/or SAPP).

Again without wishing to be limited by theory, the calcium ions (such as Ca₂+ ions) from the calcium source/salt may form ionic bridges with carboxyl groups on the protein that may aid in protein aggregation and precipitation during the processing. The extent of the aggregation may depend on calcium ion concentration. In some approaches, the proteins herein may exhibit maximum aggregation at about 40 to about 50 mM calcium ion concentration. Thus, leveraging ionic strength through the addition of calcium carbonate combined with the pH adjustment discussed above due to the acidic leavening system may further aid processing because such optional approaches may help maintain flowability in the final product when the pH is adjusted back to levels suitable for organoleptic characteristics of the ultimate product (pancakes, waffles, cakes, muffins, or the like).

After the acidic high protein slurry is formed, the dry ingredients are hydrated and the protein slurry added to this latter mixture to form a batter. The dry ingredients may be selected based on the final product (pancakes, coating, muffins, waffles, cakes, or the like). In some approaches, the dry ingredients may be selected from flour, fibers, dairy sources, starches, sweeteners, fortificants, spices, salt, leaveners, colorants, other protein sources, gums, preservatives, flavors, fats, additives/inclusions/pieces or combinations thereof.

In some approaches, the flour may be, but is not limited to, all-purpose flour, hard wheat flour, soft wheat flour, whole wheat flour, corn flour, oat flour, rice flour, barley flour, or mixtures thereof. Preferably, the flour is all purpose flour.

The batter may also include further protein sources added along with the dry ingredients. These optional protein sources may include an egg source, such as liquid whole egg, dry whole egg, liquid egg whites, dry egg whites, dairy protein (whey protein), grain protein (wheat gluten), pulse protein, algae protein, seed protein and nut protein, or mixtures thereof. In some approaches, the dry form of egg protein is preferred over the liquid form due to its higher protein content.

The batter may further include dairy sources, such as, nonfat dry milk, whole milk solids, casein, hydrolyzed milk protein, milk protein isolate, whole milk, partially defatted milk, skim milk, whey, whey products, or mixtures thereof.

Spices, herbs, salts, flavorants, colorants, fortificants and inclusions may optionally be added to the batter. Salts may include sodium chloride, potassium chloride, calcium chloride, or mixtures thereof. The fortificants may be ascorbic acid, beta carotene, biotin, calcium pantothenate, choline, folic acid, niacin, Vitamin A, Vitamin B₃, Vitamin B₂, Vitamin B₆, Vitamin B₁₂, Vitamin D₂, niacinamide, Vitamin D₃, Vitamin E, Vitamin K, boron, calcium, chromium, copper, iodine, iron, magnesium, molybdenum, nickel, potassium, selenium, vanadium, zinc, calcium citrate, calcium gluconate, calcium lactate, calcium caseinate, calcium chloride, calcium citrate malate, calcium glycerophosphate, calcium hydroxide, calcium malate, calcium stearate, calcium sulfate, or mixtures thereof Colorants may be natural colors, artificial colors, or mixtures thereof. Flavorants may be natural flavors, artificial flavors, or mixtures thereof. Inclusions may be flavor or colorants carriers, artificial or natural, or mixtures thereof.

If needed, the dry ingredients may also include one or more gums. The gums may include pectin, guar, locust bean, tara, gellan, alginate, tragacanth, karaya, Ghatti, agar, gelatin, arabic, acacia, carrageenan, xantham, cellulose, carboxymethylcellulose, hydroxypropyl methocellulose, or mixtures thereof.

The dry ingredients may also include optional starch sources. If included, the starch may include natural or modified starches, cornstarch, waxy cornstarch, rice starch, wheat starch, tapioca starch, potato starch, arrowroot starch, maize starch, oat starch, and mixtures thereof.

Lastly, the dry ingredients may further include optional amounts of preservatives (natural or artificial), such as sodium benzoate, potassium sorbate, sodium propionate, calcium propionate, or mixtures thereof as needed for a particular application.

The acidified high-protein slurry is added to the hydrated selected dry ingredients (or the dry ingredients are added to the acidified high-protein slurry). The combined mixture is blended for about 2 to about 3 minutes at about 20 to about 23° C. to form a batter. After mixing, the final batter's viscosity using a Bostwick consistometer will be between about 5 and about 12 cm, in other approaches about 7 to about 8 cm at 10 seconds. The Bostwick consistometer measures the distance in centimeters that a sample flows under its own weight for a set amount of time such as 10 seconds (for example ASTM F1080).

Next, post-adds are blended to the mixture. Post-adds may be oil, fats, additional water, and/or an emulsifier and inclusions may be further added to the batter described in the previous paragraphs. The oil or fat may be non-hydrogenated vegetable oil, non-hydrogenated shortening, partially hydrogenated vegetable oil, partially hydrogenated shortening, fully hydrogenated vegetable oil, fully hydrogenated shortening, soybean oil, cottonseed oil, canola oil, peanut oil, safflower oil, sunflower oil, coconut oil, palm oil, palm kernel oil, olive oil, butterfat oil, cocoa butter oil, tallow, lard, corn oil, or mixtures thereof. The emulsifier may be mono-glycerides, di-glycerides, propylene glycol monoester, propylene glycol diester, sodium steroyl lactylate, lecithin, polysorbate, sorbitan monostearate, glyceryl lacto ester, or mixtures thereof. In one approach, the emulsifier is lecithin. If used, the batter may include about 5 to about 10 percent of the oil or fat, about 0.1 to about 0.3 percent of the emulsifier, and/or about 0.5 to about 1 weight percent of any additional water. If used, oil is added to help with batter flow, release the food product from a cooking grid, texture and flavor in the finished food product. Lecithin is used to prevent stickiness of food on the grid upon cooking as well as release from the grid.

After the optional addition of the oil, any additional water, and/or emulsifier, the combined batter is further mixed for about 2 to about 3 minutes at about 20 to about 23° C. to form a subsequent or second or final batter.

After the oil, any additional water, and/or emulsifier is added, the subsequent or second batter may be neutralized with an alkaline leavening agent to raise the pH of the batter to about 5.9 or above, such as about 5.9 to about 6.8. While not wishing to be limited by theory, the alkaline leavener's (sodium bicarbonate) function is to release carbon dioxide upon cooking for an optimal airy/fluffy texture in the cooked waffle. It may also be used to neutralize the acidic pH of the batter that would otherwise result in sour tasting waffles. One reason the alkaline leavening agent is added at the very end of the batter making process, after the addition of the oil, is that the oil in optional embodiments may coat the protein molecules and reduce, prevent, or assist them from interacting with water as soon as the sodium bicarbonate is added. Upon its addition to the batter, sodium bicarbonate reacts very fast with acid in solution to produce carbon dioxide that will result in batter thickening. Also, sodium bicarbonate increases the pH of the batter above the protein isoelectric point causing an increase in batter viscosity. If the sodium bicarbonate is added earlier, such as at the acidified protein slurry stage, it will increase the pH above the isoelectric point and shifts the balance towards water-protein interaction instead of protein-protein interaction. To achieve such neutralization, the alkaline leavening agent may be ammonium bicarbonate, potassium bicarbonate, sodium bicarbonate, calcium carbonate, or mixtures thereof. Suitable amounts of the alkaline leavening agent may be about 0.04 to about 0.8 weight percent of the subsequent or second batter (in other approaches, 0.5 to about 0.8 weight percent, and in yet other approaches, about 0.04 to about 0.15 weight percent). Once neutralized, the batter is further mixed for about 1 to about 2 minutes at a temperature of about 20 to about 23° C. to form the final and neutralized high-protein batter.

In some approaches, the alkaline leavening agent may be an optional encapsulated neutralizing agent, such as encapsulated sodium bicarbonate. An encapsulated form of the sodium bicarbonate (or other neutralizing agent) can be formulated to release the sodium bicarbonate based on waffle cooking temperature and time. Thus, the advantage of using the optional encapsulated sodium bicarbonate is to keep the batter having the desired flowable viscosity longer and at least until depositing onto the cooking grid or other cooking surface due and/or to produce a lighter and non-sour tasting waffle. In some approaches, the encapsulated sodium bicarbonate is encapsulated or at least partially surrounded with a layer of fat or other lipid. While not wishing to be limited by theory, it is believed that an encapsulated form of sodium bicarbonate may allow more control over processing conditions (that is for instance pH and viscosity) upon addition of the alkaline leavening agent due to a delay in the pH increase as a result of the delayed release of the sodium bicarbonate, delay in the release of CO2 gas from fast reaction between sodium bicarbonate and acids in the batter including acid leaveners, and the resulting increase in viscosity from the pH increase. It is believed that use of an encapsulated sodium bicarbonate will more slowly release sodium bicarbonate molecules, increasing pH and viscosity in a controlled matter as the encapsulation layer degrades. Thus, the desired viscosity can be maintained within the optimal practical range longer and until the batter is deposited onto the cooking surface.

The final high protein batter, in some approaches, has about 8 to about 14 weight percent protein and, in other approaches, about 8 to about 12 percent protein, in other approaches, 10 to 14 percent protein, or greater than 10 percent in all instances. In other approaches, the final high protein batter has 9 to 12 grams of protein per a 70 gram serving size. The batter maintains a flowable or pourable viscosity as measured with a Bostwick consistometer of about 5 to about 12 cm, about 5 to about 10 cm, about 5 to 8 cm, about 7 to 10 cm, or about 7 to 8 cm per about 10 seconds. The first or acidified high protein slurry may have a composition of Table 1, the second or dry blend may have a composition of Table 2, and the final batter may have a composition as set forth in Table 3 below.

TABLE 1
First Mixture or Acidified High-Protein Slurry

| Ingredient | % Weight (broad) | % Weight (Narrow) |
|---|---|---|
| Water | 65-75 | 68-70 |
| Acidified Leavener(s) | 1-5 | 1.5-4.1 |
| Liquid Sweetener | 1-12 | 2-10 |
| Calcium Source | 0.2-2 | 0.7-1.5 |
| Protein | 20-40 | 25-37.5 |

TABLE 2
Dry Ingredient Portion or Pre-blend of Dry Ingredients

| Ingredient | % Weight (broad) | % Weight (Narrow) |
|---|---|---|
| Water | 30-40 | 34-37 |
| Additional Protein | 0.2-2 | 0.8-1 |
| Dry Sweetener | 8-20 | 10-15 |
| Flour | 30-45 | 35-40 |
| Calcium Source | 0.1-2 | 0.5-1 |
| Flavors | 0.1-2 | 0.3-1 |
| Spices | 0.5-7 | 1-5 |
| Fortificants | 0.01-1.5 | 0.05-1 |
| Preservatives | 0.1-3 | 0.5-2 |

TABLE 3
Final Neutralized High protein Batter

| Ingredient | % Weight (broad) | % Weight (Narrow) |
|---|---|---|
| Water | 40-50 | 45-48 |
| Acidified Leavener(s) | 0.1-2 | 0.5-1.5 |
| Liquid Sweetener | 0-8 | 0-5 |
| Protein | 7-14 | 8-12 |
| Dry Sweetener | 5-20 | 5-15 |
| Flour | 20-30 | 22-26 |
| Calcium Source | 0.1-2 | 0.5-1 |
| Flavors | 0.1-2 | 0.2-1 |
| Spices | 0.5-7 | 1-5 |
| Fortificants | 0.05-1.5 | 0.05-1 |
| Fat | 2-15 | 5-10 |
| Emulsifiers | 0.1-0.5 | 0.1-0.3 |
| Alkaline Leaveners(s) | 0.04-1 | 0.04-0.2 |
| Preservatives | 0.1-2 | 0.1-1 |

The batter may be baked, cooked, fried, or otherwise heated using conventional cooking equipment. In one approach, the batter is deposited into a waffle iron and baked at temperatures of about 300° F. to about 400° F. for about 90 to about 180 seconds.

### EXAMPLES

The following examples are illustrative of exemplary embodiments of the disclosure. In these examples as well as elsewhere in this application, all ratios, parts, and percentages are by weight unless otherwise indicated. It is intended that these examples are being presented for the purpose of illustration only and are not intended to limit the scope of the invention disclosed herein.

### Comparative Example 1

Comparative high protein batters were prepared that formed batters having unacceptable viscosity and/or flowability. The batters of this Comparative Example utilized prior methods of blending dry components into a liquid mixture. This Example attempted to reduce the level of flour to address the high batter viscosity. These methods and compositions could not achieve an acceptable flowable viscosity with high levels of proteins.

TABLE 4

| | | | | |
|---|---|---|---|---|
| | C-1 | C-2 | C-3 | C-4 |
| | % | % | % | % |
| Ingredient | Weight | Weight | Weight | Weight |

Liquid Components

| | | | | |
|---|---|---|---|---|
| Water | 45.6 | 45.6 | 45.6 | 47.3 |
| Liquid Sweetener | 0.7 | 0.7 | 0.7 | 0.7 |
| Liquid Malt | 0.1 | 0.1 | 0.1 | 0.1 |
| Liquid flavors | 0.6 | 0.6 | 0.6 | 0.6 |

Dry Components

| | | | | |
|---|---|---|---|---|
| Soy Protein Isolate | 7.9 | 7.9 | 7.9 | 8.6 |
| Additional Protein (Egg and | 0.5 | 0.5 | 0.5 | 0.6 |
| Whey) | | | | |
| Flour | 33.3 | 32.1 | 29.4 | 26.3 |
| Sweetener | 1.4 | 5.1 | 7.7 | 8.0 |
| Sodium Bicarbonate | 0.8 | 0.8 | 0.8 | 0.8 |
| Calcium Carbonate | 0.6 | 0.5 | 0.5 | 0.6 |
| Sodium Aluminum Phosphate | 0.5 | 0.5 | 0.5 | 0.6 |
| Oil | 5.1 | 5.1 | 5.1 | 5.3 |
| Flavors and Fortificants | 2.75 | 0.4 | 0.4 | 0.4 |
| Monocalcium Phosphate | 0.2 | 0.2 | 0.2 | 0.2 |

The batters of Table 4 were too thick (Bostwick consistometer viscosity at less than or about equal to 1 cm per 10 s) and had the consistency of a cake mix/dough that would not flow. Even with reductions in the levels of flour, the compositions of Table 4 could not form acceptable batters with high levels of protein.

### Comparative Example 2

In this Comparative Example, the compositions of Example 1 were utilized in a two-step mixing procedure where the soy protein, sodium aluminum phosphate, and monocalcium phosphate were separately blended with the liquid ingredients. The composition is provided in Table 5 and also resulted in a thick batter and was not otherwise evaluated further.

TABLE 5

| | |
|---|---|
| | C-5 |
| | % |
| Ingredient | Weight |

Liquid Components

| | |
|---|---|
| Water | 47.2 |
| Liquid Sweetener | 0.7 |
| Liquid Malt | 0.1 |
| Liquid flavors | 0.6 |
| Sodium Aluminum Phosphate | 1.1 |
| Monocalcium Phosphate | 0.3 |
| Soy Protein Isolate | 8.6 |

Dry Components

| | |
|---|---|
| Additional Protein (Egg and | 0.5 |
| Whey) | |
| Flour | 25.9 |
| Sweetener | 7.9 |
| Sodium Bicarbonate | 0.8 |
| Calcium Carbonate | 0.6 |
| Oil | 5.3 |
| Flavors and Fortificants | 0.3 |

### Comparative Example 3

In this Comparative Example, the compositions of Comparative Example 1 were utilized in a two-step mixing procedure where the soy protein and acidic leavening system were separately blended with the liquid ingredients. Additionally, oil was the added to the flours prior to blending with the remaining ingredients. The composition is provided in Table 6.

TABLE 6

| | |
|---|---|
| | C-6 |
| | % |
| Ingredient | Weight |

Liquid Components

| | |
|---|---|
| Water | 47.2 |
| Liquid Sweetener | 0.7 |
| Liquid Malt | 0.1 |
| Liquid Flavors | 0.6 |
| Sodium Aluminum Phosphate | 1.1 |
| Monocalcium Phosphate | 0.3 |
| Soy Protein Isolate | 8.6 |

Dry Components 1

| | |
|---|---|
| Flour | 25.9 |
| Oil | 4.9 |

Dry Components 2

| | |
|---|---|
| Additional Protein (Egg and | 0.5 |
| Whey) | |
| Sweetener | 7.9 |
| Sodium Bicarbonate | 0.8 |
| Calcium Carbonate | 0.6 |
| Oil | 0.4 |
| Flavors and Fortificants | 0.3 |

The batters of Table 6 had an unacceptable thick viscosity and not otherwise evaluated further.

### Example 1

Methods and compositions of this disclosure were evaluated for this Example utilizing the Inventive acidic leavening system and alkaline leavening agents and multi-step process to prepare high protein batters that maintained a flowable or pourable consistency. Example compositions and methods of Tables 7A and 7B having the properties of Tables 8A and 8B all provided a desirable viscosity, consistency, and organoleptic characteristics when baked as a waffle. The batters were baked by waffle iron at 300-400° F. for 90-180 s. Viscosity of the batter was measured by Bostwick consistometer, measuring distance traveled by the weight of batter in cm per 10 s.

TABLE 7A

| | 1-1 | 1-2 | 1-3 | 1-4 | 1-5 | 1-6 |
|---|---|---|---|---|---|---|
| Ingredient | % wt | % wt | % wt | % wt | % wt | % wt |
| Liquid Components 1 | | | | | | |
| Water | 23.6 | 23.6 | 23.4 | 23.6 | 23.5 | 23.9 |
| Liquid Sweetener | 0.7 | — | — | 0.7 | 0.7 | 0.7 |
| Liquid Malt | 0.1 | — | — | 0.1 | 0.1 | 0.1 |
| Liquid Flavors | 0.6 | — | — | — | — | — |
| Sodium Aluminum | 1.1 | 1.1 | 0.5 | 1.1 | — | — |
| Phosphate | | | | | | |
| Monocalcium Phosphate | 0.3 | 0.3 | 0.2 | 0.3 | 1.8 | 0.8 |
| Soy Protein Isolate | 8.6 | 8.6 | 10.1 | 8.6 | 8.6 | 8.8 |
| Liquid Components 2 | | | | | | |
| Water | 23.6 | 23.6 | 23.4 | 23.6 | 23.5 | 23.9 |
| Liquid Malt | — | 0.1 | 0.1 | — | — | — |
| Sugar | 7.7 | 7.7 | 7.6 | — | — | — |
| Liquid Sweetener | — | 0.7 | 0.7 | — | — | — |
| Liquid Flavors | — | 0.6 | 0.6 | 0.6 | 0.6 | 0.6 |
| Dry Components 2 | | | | | | |
| Flour | 25.9 | 25.9 | 25.7 | 25.9 | 25.9 | 26.3 |
| Additional Protein | 0.5 | 0.6 | 0.6 | 0.6 | 0.6 | 0.6 |
| (Egg and Whey) | | | | | | |
| Sweetener | 0.2 | 0.2 | 0.2 | 7.9 | 7.8 | 8.0 |
| Calcium Carbonate | 0.6 | 0.6 | 0.6 | 0.6 | 0.6 | 0.6 |
| Oil | 0.4 | 0.4 | 0.4 | 0.4 | 0.4 | 0.4 |
| Flavors and Fortificants | 0.3 | 0.3 | 0.3 | 0.3 | 0.3 | 0.3 |
| Post Add 1 | | | | | | |
| Oil | 4.9 | 4.9 | 4.8 | 4.9 | 4.9 | 4.9 |
| Lecithin | — | — | — | — | — | — |
| Water | — | — | — | — | — | — |
| Post Add 2 | | | | | | |
| Sodium Bicarbonate | 0.8 | 0.8 | 0.8 | 0.8 | 0.7 | 0.12 |
| Water | — | — | — | — | — | — |

TABLE 7B

| | | | |
|---|---|---|---|
| | I-7 | I-8 | I-9 |
| Ingredient | % wt | % wt | % wt |

Liquid Components 1

| | | | |
|---|---|---|---|
| Water | 24.0 | 23.3 | 23.2 |
| Liquid Sweetener | 0.7 | 0.7 | 0.7 |
| Liquid Malt | 0.1 | 0.1 | 0.1 |
| Liquid Flavors | — | — | — |
| Sodium Aluminum Phosphate | — | — | — |
| Monocalcium Phosphate | 0.5 | 0.5 | 0.6 |
| Soy Protein Isolate | 8.8 | 8.5 | 8.5 |
| Calcium Carbonate | — | — | 0.25 |

Liquid Components 2

| | | | |
|---|---|---|---|
| Water | 24.0 | 18.8 | 23.2 |
| Liquid Malt | — | — | — |
| Sugar | — | — | — |
| Liquid Sweetener | — | — | — |
| Liquid Flavors | 0.6 | 0.6 | 0.5 |

Dry Components 2

| | | | |
|---|---|---|---|
| Flour | 26.3 | 25.6 | 25.5 |
| Additional Protein (Egg and | 0.6 | 0.6 | 0.6 |
| Whey) | | | |
| Sweetener | 8.0 | 5.3 | 7.6 |
| Calcium Carbonate | 0.6 | 0.6 | 0.6 |
| Oil | 0.4 | 0.4 | 0.4 |
| Flavors and Fortificants | 0.3 | 0.3 | 0.3 |

Post Add 1

| | | | |
|---|---|---|---|
| Oil | 5.0 | 4.8 | 4.8 |
| Lecithin | — | 0.3 | 0.3 |
| Water | — | 7.6 | — |

Post Add 2

| | | | |
|---|---|---|---|
| Sodium Bicarbonate | 0.04 | 0.1 | 0.1 |
| Flavors | — | 2.5 | 2.5 |

The batters of Table 7A and 7B had the properties of Tables 8A and 8B below and all formed an acceptable viscosity and maintained a flowable consistency.

TABLE 8A

| Property | 1-1 | 1-2 | 1-3 | 1-4 | 1-5 | 1-6 |
|---|---|---|---|---|---|---|
| Protein, | 8.6 | 8.6 | 10.3 | 8.6 | 8.6 | 8.8 |
| wt. | | | | | | |
| Percent | | | | | | |
| Viscosity | Not | Not | Not | Not | <5 cm/ | 6 cm/ |
| | mea- | mea- | mea- | mea- | 10 s | 10 s |
| | sured | sured | sured | sured | | |
| pH | Not | Not | Not | Not | 6.11 | 5.85 |
| | mea- | mea- | mea- | mea- | | |
| | sured | sured | sured | sured | | |

TABLE 8B

| Property | I-7 | I-8 | I-9 |
|---|---|---|---|
| Protein, wt. Percent | 8.8 | 8.5 | 8.5 |
| Viscosity | 5 cm/10 s | 5.5 cm/10 s | 5 cm/10 s |
| pH | 5.92 | 5.91 | 5.9 |

In Table 7A, Recipes I-1 to 5 resulted in a batter that was thicker because the level of bicarbonate used was higher causing an increase in the pH above the isoelectric point of the protein.

I-6 and I-7 worked well because the level of added sodium bicarbonate was enough to slightly increase the pH of the batter to about 5.9, a pH that kept the batter flowable and the taste of the waffles acceptable (not sour).

The methods and formulas herein overcame the technical limitation of the traditional method by enabling the use of high levels of protein in the batter while keeping it flowable through process change (two-step process) and pH manipulation (around the isoelectric point of the protein) to precipitate protein and minimize protein interaction with water. However, a lower than usual sodium bicarbonate level is used (0.04% to 0.012% as opposed to 0.8%, which is about an 85% reduction) to maintain the batter flowable while achieving an acceptable taste in the cooked waffle (not sour) by targeting a pH 5.9. When added to the batter, sodium bicarbonate reacts fast with acid leaveners and other acid compounds including proteins (carboxyl groups) to release carbon dioxide in the batter. At the pH of the batter before the addition of sodium bicarbonate (5-5.8), most of the sodium bicarbonate is dissociated into the leavening gas CO2. Upon cooking the waffles at temperature (300-400° F.), the remaining sodium bicarbonate thermally decomposes into sodium carbonate, water and carbon dioxide resulting in the lighter waffle texture.

Example configurations are described herein with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method of preparing a high-protein batter for maintaining flowability of the batter, the method comprising:
blending a protein source, water, and an acidic leavening system and optionally a calcium salt to form an acidified high-protein protein slurry, the acidified high-protein protein slurry having a pH below the isoelectric point of the protein source, preferably a pH of about 4.5 or below;
adding the acidified high-protein protein slurry to dry ingredients or hydrated dry ingredients to form a batter or adding the dry ingredients or hydrated dry ingredients to the acidified high-protein slurry to form the batter;
adding a fat and optionally an emulsifier to the batter; and
neutralizing the batter through addition of an alkaline leavening system to form a neutralized high-protein batter having about 8 to about 14 weight percent protein.

2. The method of claim 1, wherein the protein source is selected from whey protein, soy protein, wheat gluten, peanut protein, pea protein, or mixtures thereof.

3. The method of any preceding claim 2, wherein the protein source is soy protein selected from soy protein isolate, soy protein concentrate, or combinations thereof.

4. The method of any preceding claim 1, wherein the acidic leavening system includes one or more ingredients selected from citric acid, lactic acid, malic acid, fumaric acid, adipic acid, acetic acid, tartaric acid, phosphoric acid, monocalcium phosphate monohydrate, anhydrous monocalcium phosphate, anhydrous dicalcium phosphate, dicalcium phosphate dihydrate, sodium acid pyrophosphate, sodium aluminum phosphate, monoaluminum phosphate, dialuminum phosphate, monoammonium phosphate, diammonium phosphate, sodium aluminum sulfate, salts thereof or mixtures thereof.

5. The method of, claim 1, wherein the dry ingredients are selected from flour, starches, sweeteners, fortificants, spices, salt, colorants, other protein sources, gums, preservatives, flavors, or combinations thereof.

6. The method of claim 1, wherein the fat is selected from non-hydrogenated vegetable oil, non-hydrogenated shortening, partially hydrogenated vegetable oil, partially hydrogenated shortening, fully hydrogenated vegetable oil, fully hydrogenated shortening, soybean oil, cottonseed oil, canola oil, peanut oil, safflower oil, sunflower oil, coconut oil, palm oil, palm kernel oil, olive oil, butterfat oil, cocoa butter oil, tallow, lard, corn oil, or mixtures thereof.

7. The method of claim 1, wherein the emulsifier is selected from mono-glycerides, di-glycerides, propylene glycol monoester, propylene glycol diester, sodium steroyl lactylate, lecithin, polysorbate, sorbitan monostearate, glyceryl lacto ester, or mixtures thereof.

8. The method of claim 1, wherein the alkaline leavening system includes one or more ingredients selected from ammonium bicarbonate, potassium bicarbonate, sodium bicarbonate, or mixtures thereof.

9. The method of claim 1, wherein the pH of the neutralized high-protein batter is about 5.9 to about 6.5

10. The method of claim 1, wherein the neutralized high-protein batter has about 8 to about 12 percent protein.

11. The method of claim 1, wherein the neutralized high-protein batter has a viscosity of about 5 to about 12 cm per about 10 seconds as measured by a Bostwick consitometer.

12. The method of claim 1, wherein a calcium salt is blended into the acidified high-protein slurry or with the dry ingredients.

13. The method of claim 12, wherein the acidified high-protein slurry includes the calcium salt and wherein the acidified high-protein slurry includes about 40 to about 50 mM of calcium ions provided by the calcium source.

14. The method of claim 13, wherein the calcium salt is calcium carbonate.

15. The method of claim 1, further including baking the neutralized high-protein batter.

16. The method of claim 15, wherein the baking is performed in a waffle iron to form a high protein waffle.

17. The method of claim 1, wherein the neutralized (final) high-protein batter includes about 8 to about 12 weight percent of the protein source, about 45 to about 48 weight percent water, about 0.5 to about 1.5 weight percent of the acidic leavening system, about 22 to about 26 weight percent of flour, about 5 to about 15 weight percent sweetener, about 5 to about 10 weight percent fat, about 0.1 to about 0.3 weight percent emulsifier, about 0.04 to about 0.8 weight percent of the alkaline leavening system (preferably about 0.04 to about 0.15 weight percent).

18. The method of claim 17, wherein the high protein batter includes about 5 to about 15 weight percent dry sweetener and about 0 to about 5 weight percent liquid sweetener.

19. The method of claim 1, wherein acidified high-protein slurry includes about 25 to about 38 weight percent of the protein source, about 68 to about 70 weight percent water, about 1.5 to about 4.5 weight percent of the acidic leavening system.

20. The method of claim 1, wherein the acidic leavening system incudes mono calcium phosphate (MCP) and sodium aluminum phosphate (SALP) in a leavening ratio of MCP to SALP of about 0.1 to about 0.4.

21. The method of claim 1, wherein about 40 to about 60 weight percent of the water is blended with the acidic leavening systems and the protein source to form the acidified protein slurry and the remaining portion of the water is blended with one or more of the dry ingredients to form a second slurry.

22. The method of claim 21, wherein the acidified high-protein slurry is added to the second slurry of hydrated dry ingredients.

23. The method of claim 22, wherein the one or more dry ingredients of the second slurry include one or more flavorants.

24. The method of claim 1, wherein liquid sweeteners selected from molasses, malt syrup, corn extract, invert sugar, and combinations thereof are blended into the acidified high-protein slurry.

25. The method of claim 1, wherein the alkaline leavening system includes an encapsulated alkaline leavening agent.
